(19) United States
(12) Patent Application Publication
(10) Pub. No.: US 2016/0008980 A1
(43) Pub. Date: Jan. 14, 2016

(54) INSPECTION SYSTEM FOR INSPECTING OBJECT USING FORCE SENSOR

(71) Applicant: FANUC CORPORATION, Minamitsuru-gun (JP)

(72) Inventors: Tetsuji Ueda, Yamanashi (JP); Masaru Oda, Yamanashi (JP)

(73) Assignee: FANUC CORPORATION, Minamitsuru-gun (JP)

(21) Appl. No.: 14/789,201

(22) Filed: Jul. 1, 2015

(30) Foreign Application Priority Data
Jul. 8, 2014 (JP) 2014-140668
Apr. 23, 2015 (JP) 2015-088615

(51) Int. Cl. B25J 9/16; B25J 19/02

(52) U.S. Cl. CPC B25J 9/1679; B25J 19/02; Y10S 901/09

(57) ABSTRACT

An inspection system includes a force sensor for detecting force acting between an inspection gauge and an object formed with a machined portion. The inspection system determines the quality of the machined portion, based on a positional relationship between the object and the inspection gauge when the inspection gauge and the machined portion are fitted to each other. The fitting operation between the inspection gauge and the machined portion is carried out by a robot which is operated in accordance with force control using a detection value of the force sensor.

### BACKGROUND ART

1. Technical Field

The present invention relates to an inspection system for inspecting the accuracy of the size of an object.

2. Description of the Related Art

A known inspection system inspects the accuracy of the size of a machined hole by moving a movable body which supports an inspection gauge sized based on the allowable size of the machined hole, toward the machined hole, so as to insert the inspection gauge into the machined hole (see JP 2002-195803 A and JP 2012-103081 A). Another known inspection system inspects the accuracy of the size of an outer diameter of a cylindrical article by moving the article through a hole having a predetermined size (see JP 2008-058069 A). As described above, it is known to inspect accuracy of the size of an object by fitting the object and the inspection gauge to each other.

However, according to the above-described known technique, it is necessary to accurately align the object relative to the inspection gauge. If the alignment is not accurate, the inspection gauge and the object may interfere with each other and cannot fit each other. This could possibly lead to the determination that the object has poor quality, irrespective of the actual accuracy of size.

Therefore, there is a need for an inspection system that can more reliably inspect the accuracy of the size of an object.

### SUMMARY OF THE INVENTION

According to a first aspect, there is provided an inspection system for inspecting accuracy of a size of a machined portion of an object, the machined portion having the same cross-section from one end face to an opposite end face, the inspection system comprising: an inspection gauge having a cross-section shaped supplementary to a cross-section shape of the machined portion; a robot configured to move the machined portion and the inspection gauge relative to each other; a force sensor configured to detect force acting between the object and the inspection gauge; and a controller configured to control the robot to fit the inspection gauge and the machined portion to each other, wherein the inspection gauge has a first inspection portion having the same cross-section shape as the machined portion and being sized so as to be smaller than a smallest allowable size of the machined portion, and a second inspection portion having the same cross-section shape as the machined portion and being sized so as to be larger than a largest allowable size of the machined portion, the controller comprising: a force control part configured to perform force control based on a detection value of the force sensor; and a quality determination part configured to determine that the object has either a good quality or a poor quality, based on a positional relationship between the machined portion and the inspection gauge when the inspection gauge and the machined portion are fitted to each other, wherein the robot is controlled to fit the inspection gauge and the machined portion to each other in accordance with the force control by the force control part.

According to a second aspect, in the inspection system according to the first aspect, the force sensor is attached to the robot, one of the object and the inspection gauge is held by the robot at a position closer to a tip end of the robot than the force sensor, and the other of the object and the inspection gauge is fixed at a position within a movable range of the robot.

According to a third aspect, in the inspection system according to the second aspect, the force sensor is attached to a wrist of the robot.

According to a fourth aspect, in the inspection system according to the first aspect, one of the object and the inspection gauge is fixed to the force sensor at a position farther than the force sensor relative to a position in which the force sensor is fixed, and the other of the object and the inspection gauge is held by the robot.

According to a fifth aspect, the inspection system according to any one of the first to fourth aspects further comprises a fitting determination part configured to determine that fitting between the inspection gauge and the machined portion is completed in the case where a relative speed between the inspection gauge and the machined portion becomes smaller than a predetermined threshold value when the robot fits the inspection gauge and the machined portion to each other.

According to a sixth aspect, in the inspection system according to the fifth aspect, the quality determination part is configured to determine the quality of the machined portion by comparing a positional information of the robot when the fitting determination part determines that the fitting is completed with positional information stored in advance.

According to a seventh aspect, in the inspection system according to any one of the first to sixth aspects, the machined portion is a hole, and the inspection gauge is a bar-like member having a supplementary shape to the hole.

According to an eighth aspect, in the inspection system according to the seventh aspect, the quality determination part is configured to determine that the object has a good quality in the case where, when the inspection gauge and the machined portion are fitted to each other, the first inspection portion of the inspection gauge can be fitted to the machined portion and the second inspection portion of the inspection gauge cannot be fitted to the machined portion, and determine that the object has a poor quality in the case where, when the inspection gauge and the machined portion are fitted to each other, the first inspection portion of the inspection gauge cannot be fitted to the machined portion or the second inspection portion of the inspection gauge can be fitted to the machined portion.

According to a ninth aspect, in the inspection system according to any one of the first to sixth aspects, the machined portion is a shaft portion, and the inspection gauge is a hole having a supplementary cross section shape to the shaft portion.

According to a tenth aspect, in the inspection system according to the ninth aspect, the quality determination part is configured to determine that the object has a good quality in the case where, when the inspection gauge and the machined portion are fitted to each other, the second inspection portion of the inspection gauge can be fitted to the machined portion and the first inspection portion of the inspection gauge cannot be fitted to the machined portion, and determine that the object has a poor quality in the case where, when the inspection gauge and the machined portion are fitted to each other, the second inspection portion of the inspection gauge cannot be fitted to the machined portion or the first inspection portion of the inspection gauge can be fitted to the machined portion.

These and other objects, features and advantages of the present invention will become more apparent in light of the detailed description of exemplary embodiments thereof as illustrated in the drawings.

### BRIEF DESCRIPTION OF THE DRAWINGS

FIG. 1A is a perspective view illustrating an exemplary configuration of an inspection system according to one embodiment.

FIG. 1B is a perspective view illustrating an exemplary configuration of the inspection system according to the embodiment.

FIG. 2 is a functional block diagram of the inspection system according to the embodiment.

FIG. 3 is a flow chart showing processes carried out by the inspection system according to the embodiment.

FIG. 4A is a perspective view illustrating an exemplary configuration of an inspection system according to another embodiment.

FIG. 4B is a perspective view illustrating an exemplary configuration of the inspection system according to the embodiment.

FIG. 5 is a perspective view illustrating an exemplary configuration of an inspection gauge in an inspection system according to yet another embodiment.

FIG. 6 is a perspective view illustrating an exemplary configuration of an inspection gauge in an inspection system according to yet another embodiment.

FIG. 7 is a perspective view illustrating an exemplary configuration of an inspection gauge in an inspection system according to yet another embodiment.

FIG. 8A is a perspective view illustrating an exemplary configuration of an inspection system using the inspection gauge shown in FIG. 7.

FIG. 8B is a perspective view illustrating an exemplary configuration of the inspection system using the inspection gauge shown in FIG. 7.

FIG. 9 is a flow chart showing processes carried out by the inspection system according to the embodiment shown in FIGS. 8A and 8B.

FIG. 10A is a perspective view illustrating an exemplary configuration of an inspection system according to yet another embodiment.

FIG. 10B is a perspective view illustrating an exemplary configuration of the inspection system according to the embodiment.

FIG. 11 is a perspective view illustrating an exemplary configuration of an inspection gauge in an inspection system according to yet another embodiment.

FIG. 12 is a perspective view illustrating an exemplary configuration of an inspection gauge in an inspection system according to yet another embodiment.

### DETAILED DESCRIPTION OF THE INVENTION

Embodiments of the present invention will be described with reference to the accompanying drawings. The illustrated constituent elements may be modified in size in relation to one another as necessary for better understanding of the present invention. The identical or corresponding constituent elements are designated with the same referential numerals.

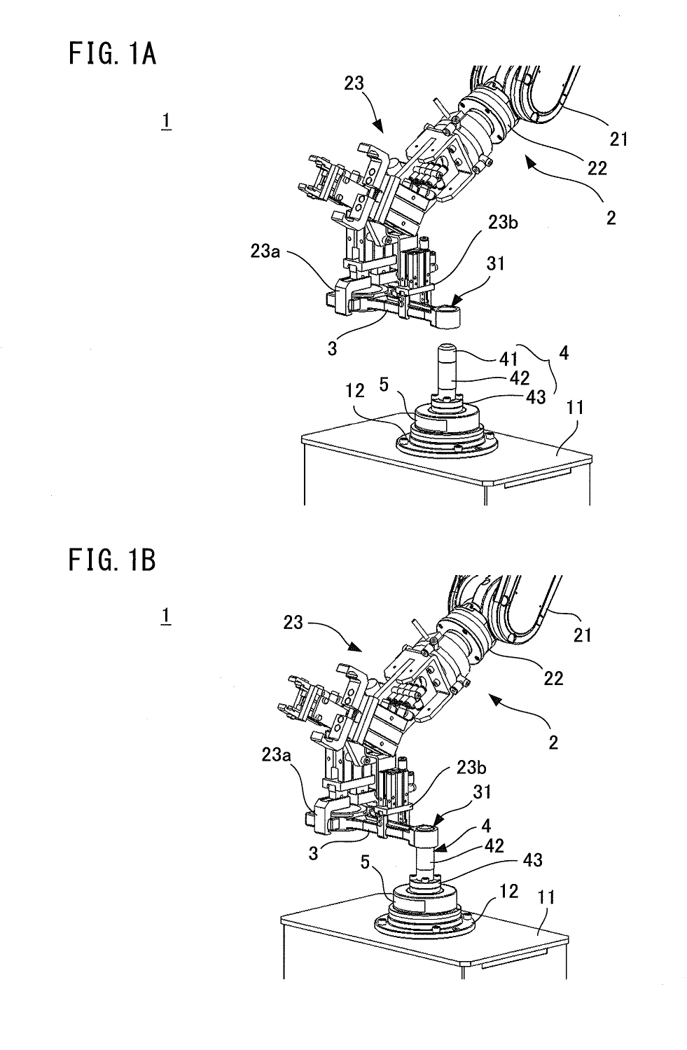

FIG. 1A is a perspective view illustrating an exemplary configuration of an inspection system 1 according to one embodiment. The inspection system 1 includes a multiple joint robot (hereinafter simply referred to as “the robot”) 2 having a plurality of joints, each of which is driven by a servo motor. In FIG. 1A, only part of the robot 2 is illustrated, including an arm 21, and a wrist 22 attached to a tip of the arm 21. The wrist 22 is provided with a hand 23 which includes a pair of chucks 23a and 23b for releasably holding an inspection object (hereinafter simply referred to as “the object”) 3. The object 3 is formed with a machined hole 31.

The machined hole 31 has a uniform cross section, e.g., a circular cross-section, along a direction in which the machined hole 31 extends (upward and downward directions in FIGS. 1A and 1B). The machined hole 31 is a through hole extending from an upper face to a lower face of the object 3. The inspection system 1 is used for an inspection of accuracy of the size of the machined hole 31. In the present embodiment, the machined hole 31 is a machined portion formed in the object 3 to be inspected.

The inspection system 1 inspects accuracy of the size of the machined hole 31 of the object 3 by inserting an inspection gauge 4 into the machined hole 31. The inspection gauge 4 is a bar-like member having the same cross section shape as the machined hole 31. The inspection gauge 4 has a smaller diameter portion 41 formed at a tip of the inspection gauge 4, a larger diameter portion 42 extending from the smaller diameter portion 41 toward a base end and having a diameter larger than that of the smaller diameter portion 41, and a flange-like base portion 43 formed at the base end of the inspection gauge 4 and having a diameter larger than that of the larger diameter portion 42.

The smaller diameter portion 41 of the inspection gauge 4 is sized so as to have a diameter slightly smaller than the smallest allowable size of the machined hole 31. The larger diameter portion 42 of the inspection gauge 4 is sized so as to have a diameter slightly larger than the largest allowable size of the machined hole 31. The base portion 43 of the inspection gauge 4 is accordingly sized so as to allow the inspection gauge 4 to be screwed to a given support (e.g., a force sensor 5 in the case of FIGS. 1A and 1B).

In another embodiment, the inspection gauge 4 may have a tapered portion between the smaller diameter portion 41 and the larger diameter portion 42 so as to have a diameter that gradually increases from the smaller diameter portion 41 toward the larger diameter portion 42. Such a tapered portion continuously is designed to connect the smaller diameter portion 41 and the larger diameter portion 42 to each other.

In the present embodiment, the inspection gauge 4 is fixed to a base seat 11 disposed within a movable range of the robot 2. The inspection system 1 further includes a force sensor 5 provided between the base seat 11 and the inspection gauge 4. As illustrated, the base portion 43 of the inspection gauge 4 is screwed to the force sensor 5. The force sensor 5 is fixed to the base seat 11 via a flange member 12 screwed into the base seat 11. The force sensor 5 is, for example, a six-axis force sensor designed to detect force acting in directions of three axle perpendicular to each other and moment around the respective axle.

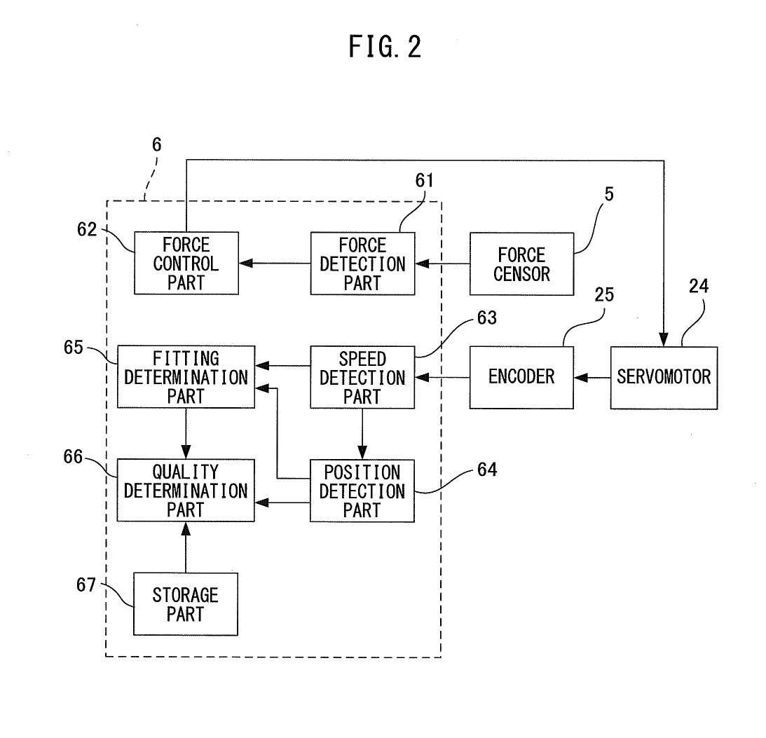

When the inspection of the machined hole 31 is carried out, the robot 2 is controlled by a controller 6 (see FIG. 2) to insert the inspection gauge 4 into the machined hole 31 of the object 3 held by the hand 23 and fit the inspection gauge 4 and the machined hole 31 to each other. FIG. 1A shows the inspection system 1 prior to the inspection of the machined hole 31. FIG. 1B shows the inspection system 1 in which the smaller diameter portion 41 of the inspection gauge 4 is inserted into the machined hole 31 after the inspection of the machined hole 31 is started.

The force sensor 5 detects force acting between the inspection gauge 4 and the object 3 when the inspection gauge 4 and the machined hole 31 are fitted to each other. The controller 6 controls the robot 2 in accordance with force control based on a detection value of the force sensor 5.

FIG. 2 is a functional block diagram of the inspection system of the embodiment. As illustrated, the controller 6 for controlling the robot 2 includes a force detection part 61, a force control part 62, a speed detection part 63, a position detection part 64, a fitting determination part 65, a quality determination part 66, and a storage part 67. The controller 6 is a digital computer having a hardware configuration which includes a CPU for executing various calculations, a RAM for temporarily storing the result of the calculations, a non-volatile memory for storing control programs and parameters, an input device such as a mouse and keyboard, and a display device such as a liquid crystal display.

The force detection part 61 detects force acting between the inspection gauge 4 and the object 3 during the inspection of the machined hole 31. The detection value of the force sensor 5 obtained by the force detection part 61 is input to the force control part 62.

The force control part 62 performs the force control for the servo motors 24 driving the joints of the robot 2, based on the detection value of the force sensor 5. The force control part 62 controls the position and posture of the robot 2 so as to decrease the detection value of the force sensor 5. Therefore, in the case where the machined hole 31 and the inspection gauge 4 are eccentric relative to each other, the force control part 62 controls the position and posture of the robot 2 so as to reduce the interference between the object 3 and the inspection gauge 4.

The speed detection part 63 detects the moving speed of the robot 2 and therefore the moving speed of the object 3 held by the hand 23 of the robot 23, by using an encoder 25 designed to detect a rotational speed of the servo motor 24,

The position detection part 64 detects the position of the servo motor 24 and therefore the position of the object 3, by calculating the integral of the moving speed obtained by the speed detection part 63.

The fitting determination part 65 determines whether or not the fitting operation for fitting the inspection gauge 4 to the machined hole 31 is completed. The fitting determination part 65 determines that the fitting operation is completed when the relative speed between the inspection gauge 4 and the machined hole 31 decreases below a predetermined threshold value.

The quality determination part 66 determines the quality of the object 3, depending on a positional relationship between the inspection gauge 4 and the machined hole 31 when it is determined by the fitting determination part 65 that the fitting operation is completed.

As described above, the smaller diameter portion 41 of the inspection gauge 4 has a diameter slightly smaller than the smallest allowable size of the machined hole 31. Therefore, when the smaller diameter portion 41 cannot be fitted to the machined hole 31 (the smaller diameter portion 41 cannot be inserted to the machined hole 41), this means that the machined hole 31 is smaller than the smallest allowable size. In this case, it is determined that the object 3 having such a machined hole 31 has a poor quality.

The larger diameter portion 42 of the inspection gauge 4 has a diameter larger than the largest allowable size of the machined hole 31. Therefore, if the larger diameter portion 42 can be fitted to the machined hole 31 (if the larger diameter portion 42 can be inserted to the machined hole 31), this means that the machined hole 31 is larger than the largest allowable size. In this case, it is determined that the object having such a machined hole 31 has a poor quality.

On the other hand, if the smaller diameter portion 41 can be fitted to the machined hole 31, and the larger diameter portion 42 cannot be fitted to the machined hole 31, it can be assumed that the machined hole 31 is within a range of the allowable size. Therefore, it is determined that the object 3 having such a machined hole 31 has a good quality.

The storage part 67 stores a threshold value used for the determination by the fitting determination part 65. The storage part 67 also stores positional information used for the determination by the quality determination part 66. Specifically, the storage part 67 stores first positional information and second positional information. The first positional information corresponds to a position at which the smaller diameter portion 41 of the inspection gauge 4 is fitted to the machined hole 31. The second positional information corresponds to a position at which the larger diameter portion 42 of the inspection gauge 4 is fitted to the machined hole 31. A position sensor (not shown) may also be used to detect a positional relationship between the inspection gauge 4 and the machined hole 31 when the fitting operation is completed. In this case, it is not necessary to store the first and second positional information.

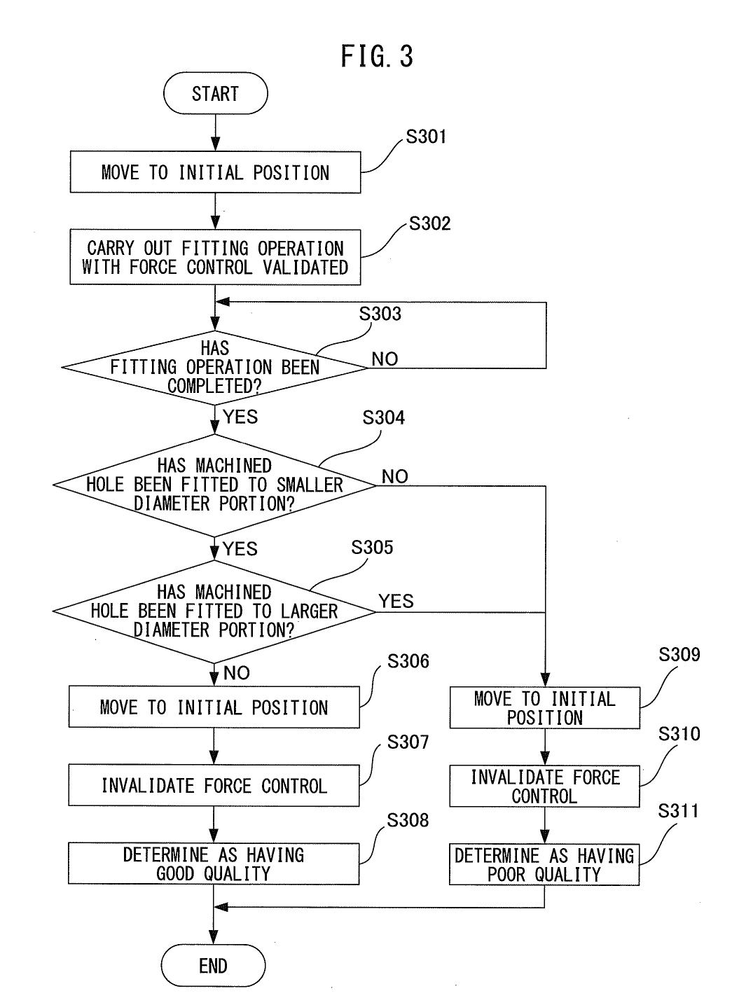

FIG. 3 is a flow chart showing processes carried out by the inspection system 1 according to the embodiment. The inspection process of the machined hole 31 is started in the state where the object 3 is held by the hand 23 of the robot 2. First, at step S301, the controller 6 drives the robot 2 to position the object 3 at a predetermined position relative to the inspection gauge 4 (i.e., at an initial position) (see FIG. 1A). At the initial position, the object 3 and the inspection gauge 4 are not in contact with each other.

At step S302, the force control part 62 validates the force control for the robot 2 and carries out the fitting operation by the robot 2 according to a predetermined teaching program. The fitting operation is carried out by inserting the inspection gauge 4 into the machined hole 31 and moving the object 3 toward the base 43 of the inspection gauge 4. During the fitting operation, the position control by which the robot 2 is controlled to insert the inspection gauge 4 into the machined hole 31 and the force control by which the robot 2 is controlled to reduce force acting between the object 3 and the inspection gauge 4 are implemented in combination with each other.

At step S303, the fitting determination part 65 determines whether or not the fitting operation has been completed. The fitting determination part 65 determines that the fitting operation has been completed when the movement speed of the robot 2, or in other words, the relative speed between the object 3 and the inspection gauge 4 is below a predetermined threshold value.

In the case where the result of the determination at step S303 is positive, the process proceeds to step S304 at which the quality determination part 66 determines whether or not the machined hole 31 can be fitted to the smaller diameter portion 41 of the inspection gauge 4. The determination at step S304 is carried out by comparing the position of the robot 2 at the time of completion of the fitting operation with the first positional information stored by the storage part 67.

In the case where the result of the determination at step S304 is positive, the process proceeds to step S305 at which the quality determination part 66 determines whether or not the machined hole 31 can be fitted to the larger diameter portion 42 of the inspection gauge 4. The determination at step S305 is carried out by comparing the position of the robot 2 at the time of completion of the fitting operation with the second positional information stored by the storage part 67.

In the case where the result of the determination at step S305 is negative, the process proceeds to step S306 at which the robot 2 is moved to the initial position before the fitting operation is carried out. Subsequently, the force control is invalidated (step S307), and it is determined that the object 3 has a good quality.

On the other hand, in the case where the result of the determination at step S304 is negative, or the result of the determination at step S305 is positive, the process proceeds to step S309 at which the robot 2 is moved to the initial position. Subsequently, the force control is invalidated (step S310), and it is determined that the object 3 has a poor quality (step S311).

According to the inspection system 1 of the present embodiment, the robot 2 performs the fitting operation for fitting the inspection gauge 4 and the machined hole 31 to each other in accordance with the force control based on a detection value of the force sensor 5. Therefore, even if the alignment between the inspection gauge 4 and the machined hole 31 of the object 3 is insufficient, and the inspection gauge 4 interferes with the object 3, the position and posture of the robot 2 is changed so as to avoid the interference. As a result, even if the alignment between the inspection gauge 4 and the object 3 is not accurate, the inspection of the machined hole 31 can be carried out accordingly. In other words, there is no need for a preceding process for aligning the inspection gauge 4 and the object 3 relative to each other. In addition, there is no need for an additional component used for the alignment, such as a vision sensor. Further, since the force sensor 5 is fixed to the base seat 11, the load applied to the robot 2 can be reduced.

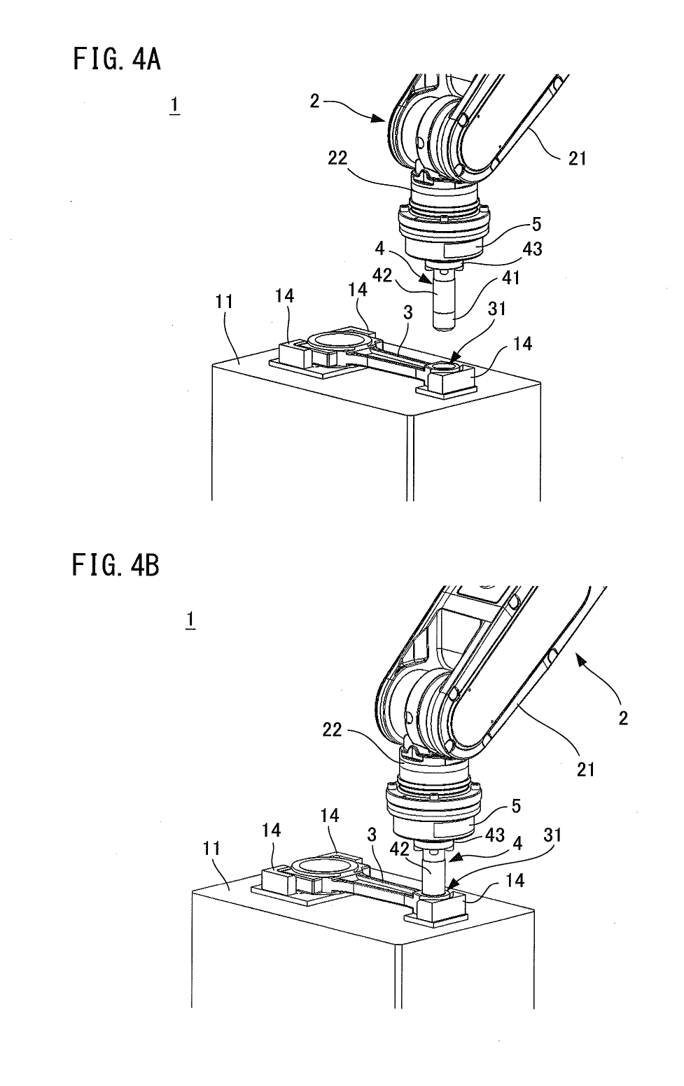

FIGS. 4A and 4B are perspective views illustrating an exemplary configuration of an inspection system 1 according to another embodiment. FIG. 4A illustrates the inspection system 1 before the inspection gauge 4 is fitted to the machined hole 31. FIG. 4B illustrates the inspection system 1 after the inspection gauge 4 is fitted to the machined hole 31. In the following explanation, the matters that have already been described in relation to the above embodiment will be omitted.

According to the present embodiment, the force sensor 5 and the inspection gauge 4 are attached to the wrist 22 of the robot 2. On the other hand, the object 3 formed with the machined hole 31 is fixed to the base seat 11 disposed within a movable range of the robot 2. The object 3 is fixed to the base seat 11 by three fixing members 14. In the inspection system 1 according to the present embodiment, the inspection gauge 4 and the machined hole 31 are fitted to each other while the robot 2 is controlled in accordance with the force control, similarly to the embodiment described above with reference to FIGS. 1A and 1B. Therefore, even if the alignment between the inspection gauge 4 and the object 3 is not accurate, the inspection of the size accuracy of the machined hole 31 can be implemented accordingly.

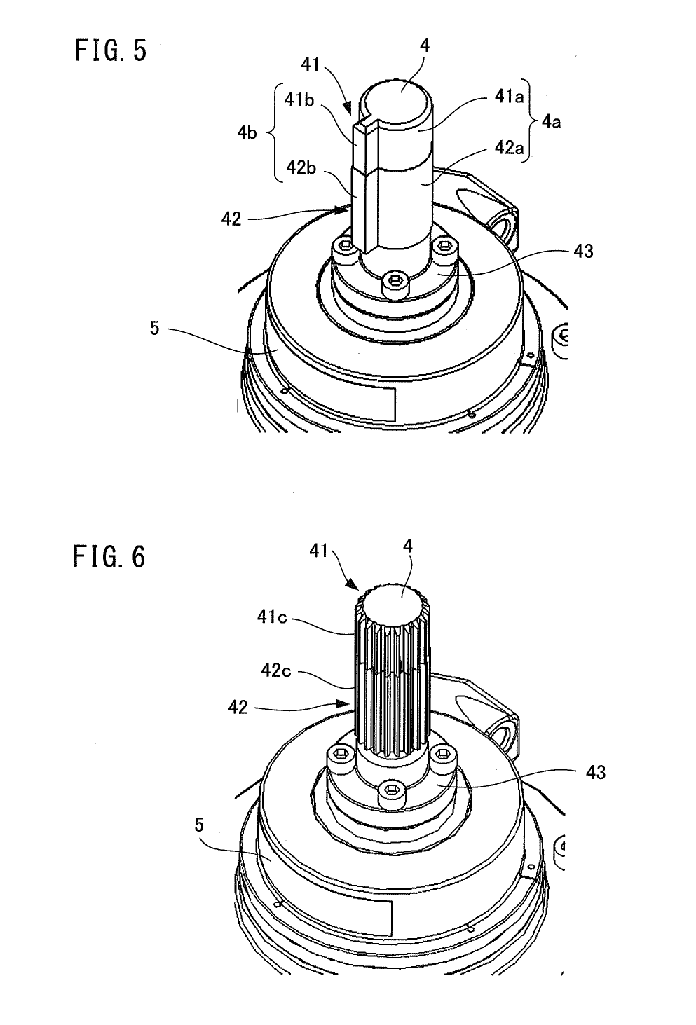

FIG. 5 illustrates an exemplary configuration of an inspection gauge used in an inspection system according to yet another embodiment. The inspection gauge 4 has a cylindrical portion 4a having cylindrical cross-section and a protruding piece 4b protruding radially outwardly from a portion of the outer circumference of the cylindrical portion 4a. In this case, the machined hole (not shown) formed in the object has a combined shape of a circular shape portion corresponding to the cylindrical portion 4a and a groove portion corresponding to the protruding piece 4b

The inspection gauge 4 has a smaller diameter portion 41 and a larger diameter portion 42, similarly to the above-described embodiment. The smaller diameter portion 41 of the inspection gauge 4 has a cylindrical portion 41a and a protruding piece 41b, each of which is sized so as to be slightly smaller than a smallest allowable size of the machined hole. The larger diameter portion 42 of the inspection gauge 4 has a cylindrical portion 42a and a protruding piece 42b, each of which is sized so as to be slightly larger than the largest allowable size.

FIG. 6 illustrates an exemplary configuration of an inspection gauge used for an inspection system according to yet another embodiment. In the present embodiment, the inspection gauge 4 is a spline shaft shaped correspondingly to the machined hole. In other words, the machined hole (not shown) is a spline hole formed with a number of grooves along its circumference. The inspection gauge 4 has a smaller diameter portion 41 and a larger diameter portion 42 similar to the above-described embodiments. The smaller diameter portion 41 and the larger diameter portion 42 are formed with a number of grooves 41c and 42c on their outer circumferential faces so as to form a supplementary shape to the machined hole. The smaller diameter portion 41 of the inspection gauge 4 is sized so as to be slightly smaller than the smallest allowable size of the machined hole. The larger diameter portion 42 of the inspection gauge 4 is sized so as to be slightly larger than the largest allowable size of the machined hole.

Even in the case where the machined hole has a non-circular shape, the inspection of the object can be implemented in the same manner as described above with reference to FIG. 3, by using the inspection gauge 4 having a shape corresponding to the machined hole as shown in FIGS. 5 and 6.

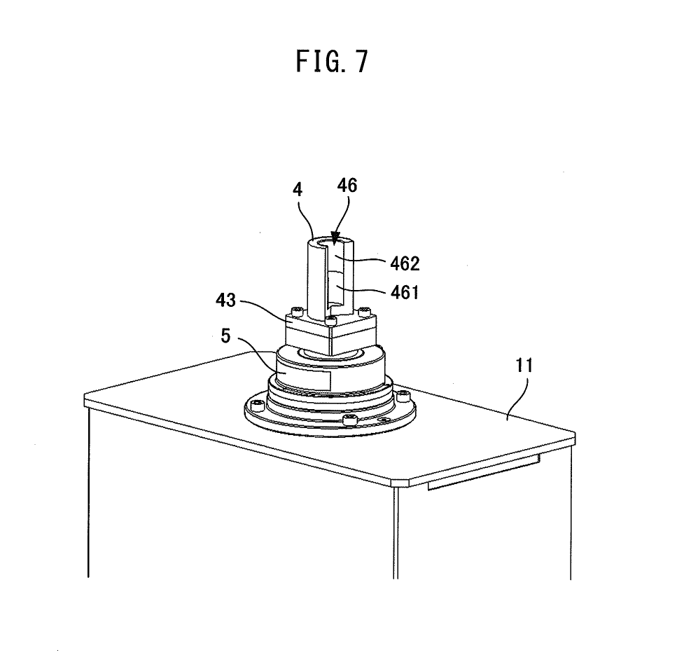

FIG. 7 illustrates an exemplary configuration of an inspection gauge 4 used for an inspection system according to yet another embodiment. In the present embodiment, the inspection gauge 4 is formed with a hole 46 for receiving the object 3. In FIG. 7, part of the inspection gauge 4 is cut out so that the hole 46 can be seen. The hole 46 has a larger diameter portion 462 on a tip end side of the inspection gauge 4 and a smaller diameter portion 461 on a base end side of the inspection gauge 4. The larger diameter portion 462 and the smaller diameter portion 461 may be provided adjacent to each other, or there may be a tapered portion which has a diameter continuously changing between the larger diameter portion 462 and the smaller diameter portion 461. The inspection gauge 4 is fixed to the base seat 11 via the force sensor 5.

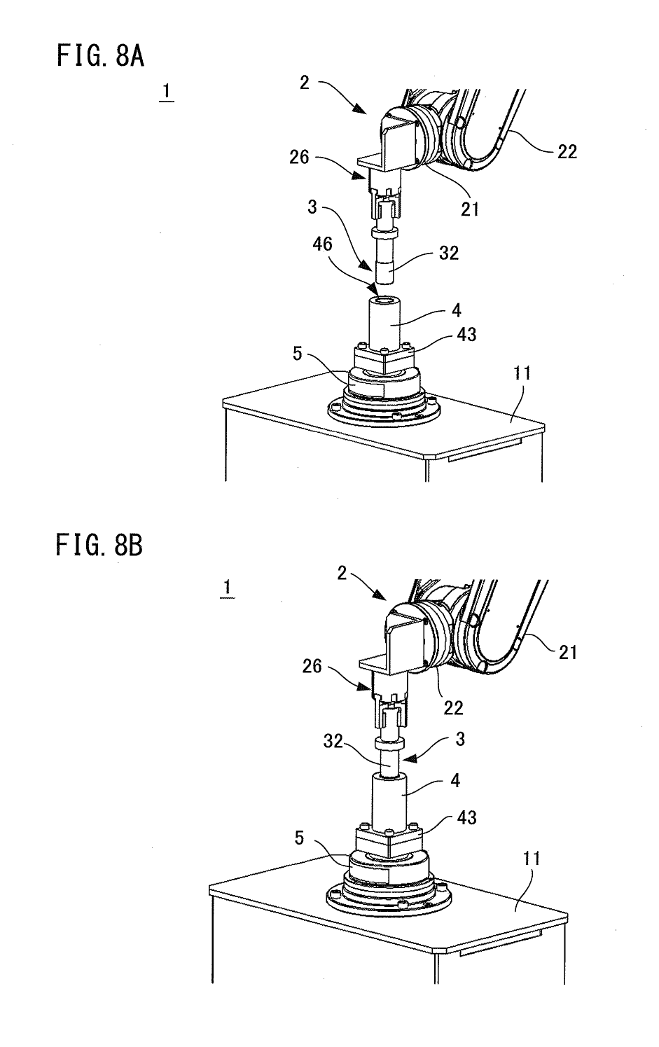

FIG. 8A and FIG. 8B illustrate an inspection system 1 using the inspection gauge shown in FIG. 7. In the present embodiment, the object 3 has a shaft portion 32 of a circular shape in cross-section, which is shaped by a lathe, for example. The inspection system 1 is used to inspect the accuracy of the size of the shaft portion 32. Accordingly, the shaft portion 32 is a machined portion formed on the object 3 to be inspected. The object 3 is fixed to the robot 2 via a jig 26 attached to the wrist 22 of the robot 2. The larger diameter portion 462 of the inspection gauge 4 is sized so as to be slightly larger than the largest allowable size of the shaft portion 32. The smaller diameter portion 461 of the inspection gauge 4 is sized so as to be slightly smaller than the smallest allowable size of the shaft portion 32.

In the present embodiment, the robot 2 is driven to fit the shaft portion 32 of the object 3 to the hole 46 of the inspection gauge 4, in accordance with the force control based on a detection value of the force sensor 5, similarly to the above-described embodiments. FIG. 8A illustrates the inspection system 1 before the fitting operation is started. Referring to FIG. 8B, part of the shaft portion 32 is inserted into the hole 46. The quality determination part 66 of the robot controller 6 (see FIG. 2) determines whether or not the object 3 has a good quality or a poor quality, based on the positional relationship between the object 3 and the inspection gauge 4 when the shaft portion 32 and the hole 46 are fitted to each other. Specifically, when the shaft portion 32 can be fitted to the larger diameter portion 462 of the inspection gauge 4 and cannot be fitted to the smaller diameter portion 461 of the inspection gauge 4, it is determined that the object 3 has a good quality. On the other hand, when the shaft portion 32 cannot be fitted to the larger diameter portion 462 of the inspection gauge 4 or when the shaft portion 32 can be fitted to the smaller diameter portion 461 of the inspection gauge 4, it is determined that the object 3 has a poor quality.

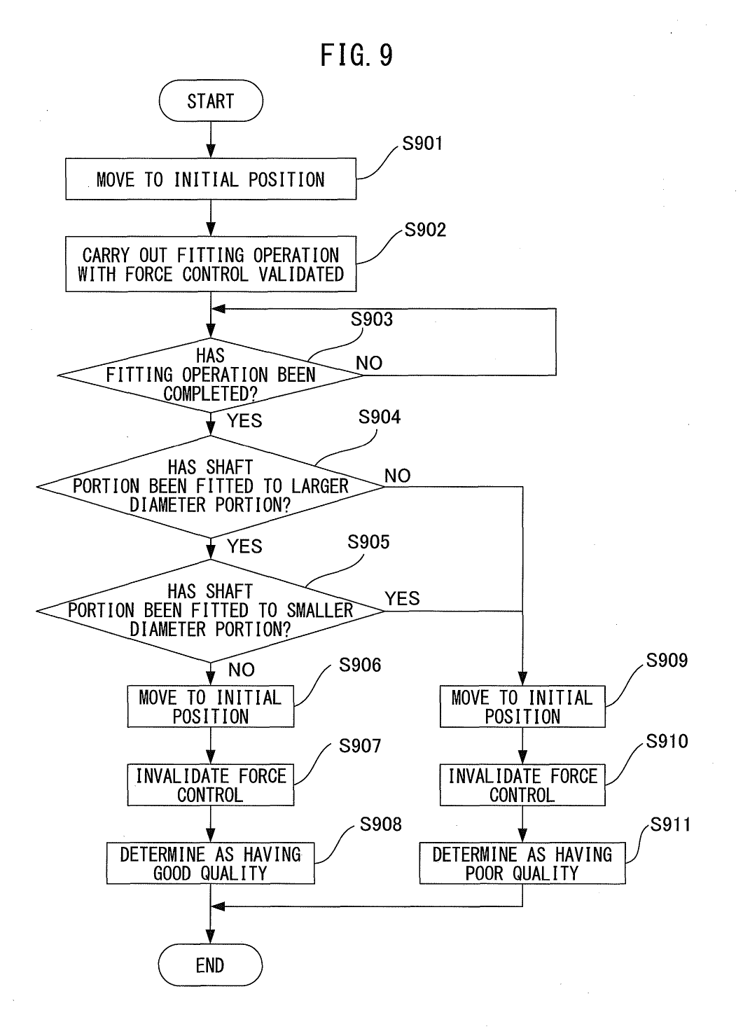

FIG. 9 is a flow chart showing the inspection process of the object 3 using the inspection gauge 4 shown in FIG. 7. In the present embodiment, the inspection gauge 4 is formed with the hole 46 having the smaller diameter portion 461 and the larger diameter portion 462. Accordingly, the flowchart is different from that shown in FIG. 3 with respect to the determination process by the quality determination part 66. The processes at steps S901 to S903 are the same as steps S301 to S303 of FIG. 3, and therefore the description thereon will be omitted.

At step S904, it is determined whether or not the shaft portion 32 of the object 3 can be fitted to the larger diameter portion 462 of the inspection gauge 4. When the result of the determination at step S904 is positive, the process proceeds to step S905 at which it is determined whether or not the shaft portion 32 can be fitted to the smaller diameter portion 461 of the inspection gauge 4. The determinations at steps S904 and S905 are carried out based on the comparison between the position of the robot 2 at the time of completion of the fitting operation, and the positional information stored in the storage part 67.

On the other hand, when the result of the determination at step S904 is negative, the processes at S909 to S911 are implemented so that the quality determination part 66 determines that the object 3 has a poor quality. When the shaft portion 32 cannot be fitted to the larger diameter portion 462 which is larger than the largest allowable size, this means that the shaft portion 32 is larger than the largest allowable size. Therefore, the object 3 with such a shaft portion 32 is determined as having a poor quality.

When the result of the determination at step S905 is negative, it can be assumed that the shaft portion 32 is within a range of allowable size. Accordingly, the processes at steps S906 to S908 are implemented so that the quality determination part 66 determines that the object 3 has a good quality.

On the other hand, when the result of the determination at step S905 is positive, this means that the shaft portion 32 is smaller than the smallest allowable size. Therefore, the processes at steps S909 to S911 are implemented so that the quality determination part 66 determines that the object 3 has a poor quality.

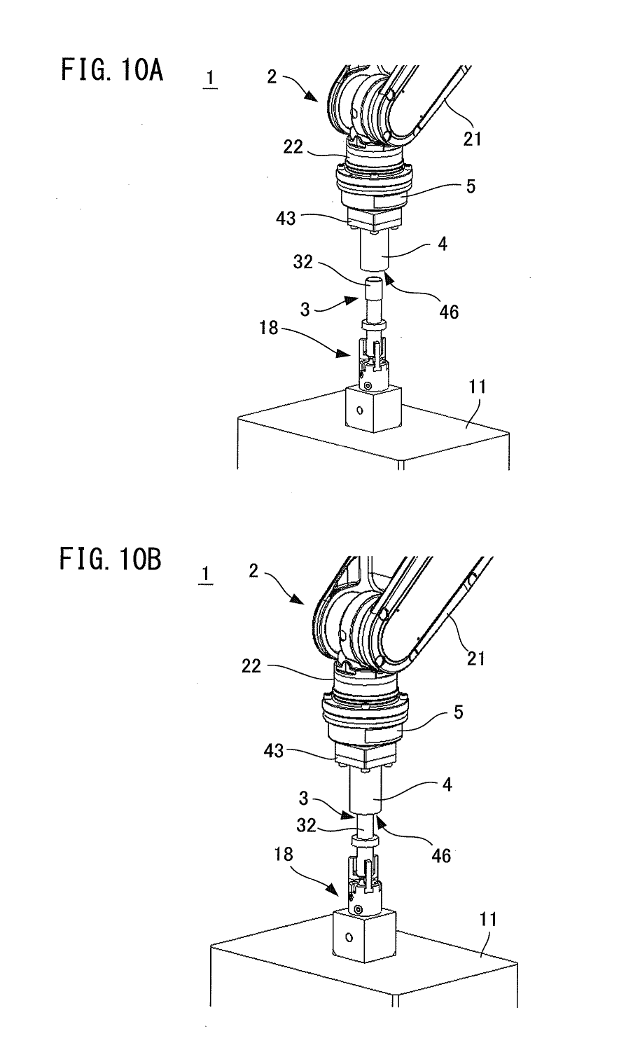

FIGS. 10A and FIG. 10B illustrate an exemplary configuration of an inspection system according to yet another embodiment. According to the present embodiment, the object 3 having the shaft portion 32 is fixed to a jig 18 provided on the base seat 11. On the other hand, the inspection gauge 4 is attached to the wrist 22 of the robot 2 via the force sensor 5.

When the inspection of the object 3 is implemented, the robot 2 is positioned at an initial position shown in FIG. 10A. When the fitting operation between the shaft portion 32 and the hole 46 is initiated, the robot 2 moves the inspection gauge 4 toward the object 3 while the force control is carried out by the force control part 62 of the robot controller 6. FIG. 10 B illustrates the state in which part of the object 3 is inserted into the hole 46 of the inspection gauge 4.

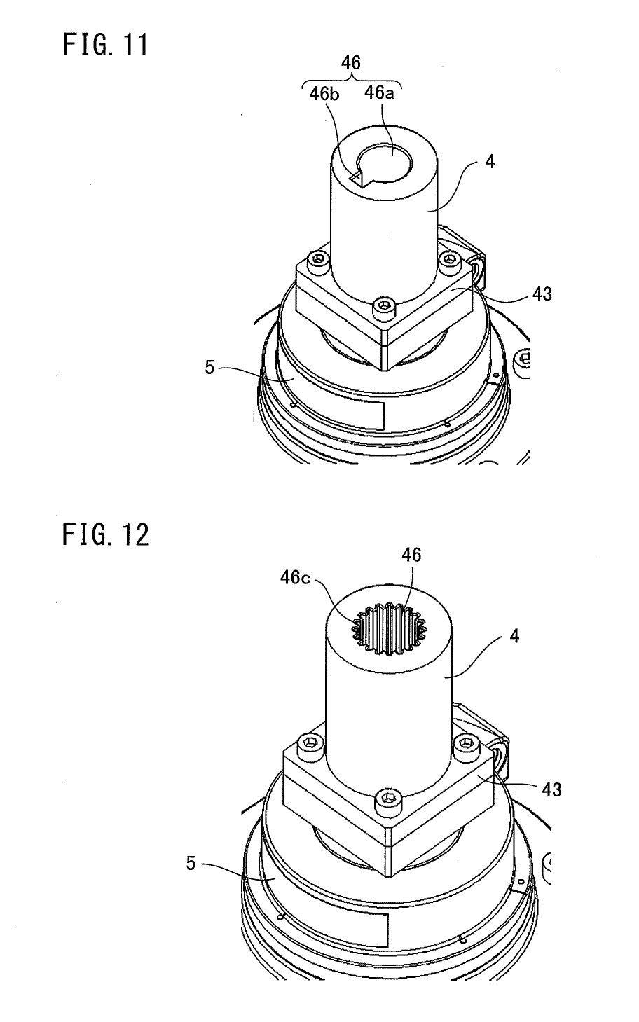

FIG. 11 illustrates an exemplary configuration of an inspection gauge used for an inspection system according to yet another embodiment. The inspection gauge 4 is provided with a hole 46 having a supplementary shape to the object (not shown). As illustrated, the hole 46 of the inspection gauge 4 has a circular portion 46a and a groove 46b depressed radially outwardly from a portion of the outer circumference of the circular portion 46a.

FIG. 12 illustrates an exemplary configuration of an inspection gauge used for an inspection system according to yet another embodiment. The inspection gauge 4 is provided with a hole 46 having a supplementary shape to the object (not shown). In the present embodiment, the hole 46 is a spline hole formed with a number of grooves along the circumference thereof.

As described with reference to several examples, the object to be inspected is not limited to a particular shape. For example, the present invention may also be applied to an object provided with a machined hole or a shaft portion having elongated cross-section, such as an oval shape.

### Effect of the Invention

According to the present invention, the inspection system includes the force sensor for detecting force acting between the inspection gauge and the inspection object. The robot is operated in accordance with the force control using a detection value of the force sensor to fit the inspection gauge and the object to each other. Due to the force control, the relative position between the inspection gauge and the object can be adjusted during the fitting operation. Accordingly, there is no need to accurately align the inspection gauge and the object relative to each other prior to the inspection, in order to inspect the accuracy of the size of the object accordingly.

Although various embodiments and variants of the present invention have been described above, it is apparent for a person skilled in the art that the intended functions and effects can also be realized by other embodiments and variants. In particular, it is possible to omit or replace a constituent element of the embodiments and variants, or additionally provide a known means, without departing from the scope of the present invention. Further, it is apparent for a person skilled in the art that the present invention can be implemented by any combination of features of the embodiments either explicitly or implicitly disclosed herein.

What is claimed is:

1. An inspection system for inspecting accuracy of a size of a machined portion of an object, the machined portion having the same cross-section from one end face to an opposite end face, the inspection system comprising:
an inspection gauge having a cross-section shaped supplementary to a cross-section shape of the machined portion;
a robot configured to move the machined portion and the inspection gauge relative to each other;
a force sensor configured to detect force acting between the object and the inspection gauge; and
a controller configured to control the robot to fit the inspection gauge and the machined portion to each other,
wherein the inspection gauge has a first inspection portion having the same cross-section shape as the machined portion and being sized so as to be smaller than a smallest allowable size of the machined portion, and a second inspection portion having the same cross-section shape as the machined portion and being sized so as to be larger than a largest allowable size of the machined portion,
the controller comprising:
a force control part configured to perform force control based on a detection value of the force sensor; and
a quality determination part configured to determine that the object has either a good quality or a poor quality, based on a positional relationship between the machined portion and the inspection gauge when the inspection gauge and the machined portion are fitted to each other,
wherein the robot is controlled to fit the inspection gauge and the machined portion to each other in accordance with the force control by the force control part.

2. The inspection system according to claim 1, wherein the force sensor is attached to the robot,
one of the object and the inspection gauge is held by the robot at a position closer to a tip end of the robot than the force sensor, and
the other of the object and the inspection gauge is fixed at a position within a movable range of the robot.

3. The inspection system according to claim 2, wherein the force sensor is attached to a wrist of the robot.

4. The inspection system according to claim 1, wherein one of the object and the inspection gauge is fixed to the force sensor at a position farther than the force sensor relative to a position in which the force sensor is fixed, and
the other of the object and the inspection gauge is held by the robot.

5. The inspection system according to claim 1, further comprising a fitting determination part configured to determine that fitting between the inspection gauge and the machined portion is completed in the case where a relative speed between the inspection gauge and the machined portion becomes smaller than a predetermined threshold value when the robot fits the inspection gauge and the machined portion to each other.

6. The inspection system according to claim 5, wherein the quality determination part is configured to determine the quality of the machined portion by comparing a positional information of the robot when the fitting determination part determines that the fitting is completed with positional information stored in advance.

7. The inspection system according to claim 1, wherein the machined portion is a hole, and the inspection gauge is a bar-like member having a supplementary shape to the hole.

8. The inspection system according to claim 7, wherein the quality determination part is configured to determine that the object has a good quality in the case where, when the inspection gauge and the machined portion are fitted to each other, the first inspection portion of the inspection gauge can be fitted to the machined portion and the second inspection portion of the inspection gauge cannot be fitted to the machined portion, and determine that the object has a poor quality in the case where, when the inspection gauge and the machined portion are fitted to each other, the first inspection portion of the inspection gauge cannot be fitted to the machined portion or the second inspection portion of the inspection gauge can be fitted to the machined portion.

9. The inspection system according to claim 1, wherein the machined portion is a shaft portion, and the inspection gauge is a hole having a supplementary cross section shape to the shaft portion.

10. The inspection system according to claim 9, wherein the quality determination part is configured to determine that the object has a good quality in the case where, when the inspection gauge and the machined portion are fitted to each other, the second inspection portion of the inspection gauge can be fitted to the machined portion and the first inspection portion of the inspection gauge cannot be fitted to the machined portion, and determine that the object has a poor quality in the case where, when the inspection gauge and the machined portion are fitted to each other, the second inspection portion of the inspection gauge cannot be fitted to the machined portion or the first inspection portion of the inspection gauge can be fitted to the machined portion.
